(19) United States
(12) Patent Application Publication
(10) Pub. No.: US 2016/0115384 A1
(43) Pub. Date: Apr. 28, 2016

(54) PHOSPHOR COMPOSITION WITH ENHANCED EMISSION UNDER THE EYE SENSITIVITY CURVE

(71) Applicant: Cree, Inc., Durham, NC (US)

(72) Inventors: Iliya Todorov, Durham, NC (US); Harry A. Seibel, Durham, NC (US); David M. Clatterbuck, Raleigh, NC (US)

(21) Appl. No.: 14/525,551

(22) Filed: Oct. 28, 2014

(51) Int. Cl. C09K 11/77; H05B 33/12

(52) U.S. Cl. CPC C09K 11/7734; H05B 33/12

(57) ABSTRACT

A light emitting diode (LED) component comprises an LED comprising a dominant wavelength in a range of from about 425 nm to about 475 nm, and a phosphor composition in optical communication with the LED. The phosphor composition comprises a primary phase and one or more additional phases. An emission spectrum of the phosphor composition has a peak emission wavelength of between about 640 nm and about 670 nm and a FWHM of between about 40 nm and 65 nm. An x-ray diffraction pattern of the phosphor composition comprises a first intensity peak corresponding to the one or more additional phases at a 2-theta value of from about 26.5° to about 26.8°.

### TECHNICAL FIELD

The present disclosure is related generally to phosphors for light emitting devices and more particularly to a red phosphor with enhanced emission under the eye sensitivity curve.

### BACKGROUND

Light emitting diodes (LEDs) are solid state devices that convert electric energy to light, and generally comprise one or more active layers of semiconductor material sandwiched between oppositely doped layers so as to define a p-n junction. When a bias is applied across the p-n junction, holes and electrons are injected into the active layer where they recombine to generate light in a process called injection electroluminescence. Light may be emitted from the active layer through all surfaces of the LED.

As most LEDs are nearly monochromatic light sources that appear to emit light having a single color, light emitting devices or lamps including multiple LEDs that can emit light of different colors have been employed to produce white light. In these devices, the different colors of light emitted by the individual LEDs combine to produce a desired intensity and/or color of white light. For example, by simultaneously energizing red, green and blue light emitting LEDs, the resulting combined light may appear white, or nearly white.

As an alternative to combining individual LEDs to produce light emitting devices having a particular light emission spectrum, luminescent materials, or phosphors, may be used to control the color of light emitted from LEDs. A phosphor may absorb a portion of the light emitted from an LED at a given wavelength and re-emit the light at different wavelength via the principle of photoluminescence. The conversion of light having a shorter wavelength (or higher frequency) to light having a longer wavelength (or lower frequency) may be referred to as down conversion. For example, a down-converting phosphor may be combined with a blue LED to convert some of the blue wavelengths to yellow wavelengths in order to generate white light. White light may also be generated by utilizing red and green/yellow phosphors with a blue LED. Widely used yellow phosphors are based on yttrium aluminum garnet (YAG) doped with cerium. Commercially important red phosphors include CaAlSiN₃ doped with europium or rare earth-doped alkali earth sulfides such as CaS or SrS.

The color rendering index (CRI) of a white-light emitting LED component is indicative of the accuracy with which the LED component can reproduce the colors of various objects in comparison with an ideal or natural light source. LED components with a high CRI (e.g., greater than 85) are desired. It would be advantageous to improve the color rendering ability of LED components without sacrificing energy efficiency.

### BRIEF SUMMARY

An improved phosphor composition that may show enhanced emission under the eye sensitivity curve is described herein. A LED component that includes the improved phosphor composition is also described, as well as a method of producing the phosphor composition. The LED component may exhibit a higher light conversion efficiency at wavelengths where the human eye shows high sensitivity.

The phosphor composition comprises, according to one embodiment, a primary phase and one or more additional phases, where an emission spectrum of the phosphor composition has a peak emission wavelength of between about 640 nm and about 670 nm and a FWHM of between about 40 nm and 65 nm. An x-ray diffraction pattern of the phosphor composition comprises a first intensity peak at a 2-theta value of from about 26.5° to about 26.8°, the first intensity peak corresponding to the one or more additional phases.

The phosphor composition comprises, according to another embodiment, a primary phase and one or more additional phases, where the primary phase comprises a chemical formula of Sr_{1-x-y}EuₓR_{y}[Li_{1-z}A_{z}Al₃₋ₐMₐN₄], where R is selected from the group consisting of Ca and Ba, A is selected from the group consisting of Na and K, and M is selected from the group consisting of B, Ga, Si, Ge, and C, and 0.001≦≦0.02, 0≦y≦0.5, 0≦z≦0.5, and 0≦a≦1.0. An x-ray diffraction pattern of the phosphor composition comprises a first intensity peak at a 2-theta value of from about 26.5° to about 26.8°, the first intensity peak corresponding to the one or more additional phases.

The LED component comprises, according to one embodiment, an LED comprising a dominant wavelength in a range of from about 425 nm to about 475 nm, and a first phosphor composition and a second composition in optical communication with the LED. The first phosphor composition comprises an emission spectrum having a peak emission wavelength of between about 640 nm and about 670 nm and a FWHM of between about 40 nm and 65 nm. The second phosphor composition comprises an emission spectrum having a peak emission wavelength of from about 600 nm to less than 640 nm.

The method comprises forming a reaction mixture comprising a first precursor comprising Sr, a second precursor comprising Li, a third precursor comprising Al, and a fourth precursor comprising Eu, and heating the reaction mixture in an environment comprising nitrogen gas at a temperature sufficient to form a phosphor composition that comprises a primary phase and one or more additional phases. The primary phase comprises Sr, Li, Al, N, and Eu, and an x-ray diffraction pattern of the phosphor composition comprises a first intensity peak corresponding to the one or more additional phases at a 2-theta value of from about 26.5° to about 26.8°.

### BRIEF DESCRIPTION OF THE DRAWINGS

FIG. 1A is an emission spectrum of an exemplary red phosphor composition according to the present disclosure in comparison with emission spectra from conventional red phosphor compositions.

FIG. 1B shows excitation spectra for the same red phosphor compositions.

FIG. 2 shows the eye sensitivity function and luminous efficacy as a function of wavelength.

FIG. 3 shows an x-ray diffraction pattern from exemplary red phosphor composition 1.

FIG. 4 shows an x-ray diffraction pattern from exemplary red phosphor composition 2.

FIG. 5 shows an x-ray diffraction pattern from exemplary red phosphor composition 3.

FIG. 6 is a schematic of an exemplary LED component that shows an exemplary red phosphor composition in optical communication with a blue LED.

### DETAILED DESCRIPTION

### Definitions and Terminology

As used in the present disclosure, a “phosphor” or “phosphor composition” may refer to a material that absorbs light at one wavelength and re-emits the light at a different wavelength, where the re-emission includes visible light. The term phosphor may be used herein to refer to materials that are sometimes referred to as fluorescent and/or phosphorescent materials.

Also as used herein, “host lattice” refers to a crystal lattice of a given material that further includes a dopant, or “activator.”

“Peak emission wavelength” refers to the wavelength of light at which the emission intensity of a phosphor or an LED is a maximum. LEDs typically have a light emission spectrum or intensity distribution that is tightly centered about the peak emission wavelength. The light emission spectrum of a phosphor or an LED may be further characterized in terms of the width of the intensity distribution measured at half the maximum light intensity (referred to as the full width at half maximum or “FWHM” width).

“Dominant wavelength” refers to the wavelength of light that has the same apparent color as the light emitted from the phosphor or LED as perceived by the human eye. Thus, the dominant wavelength differs from the peak wavelength in that the dominant wavelength takes into account the sensitivity of the human eye to different wavelengths of light.

A first device or phosphor that is described as being “in optical communication with” a second device or phosphor is positioned such that light emitted from the first device reaches the second device.

As used herein, “ccx” or “CCx” refers to correlated color X and “ccy” or “CCy” refers to correlated color y, where these coordinates (ccx, ccy) are calculated using the standard color matching functions that describe the 1931 CIE color space or chromaticity diagram.

The term “bins” or “color bins” refer to partitions of the 1931 CIE chromaticity diagram as defined by ANSI C78.377.

A “reducing environment” is an environment controlled to include substantially no oxygen and/or oxidizing gases. The reducing environment may further contain actively reducing gases.

It is understood that when an element such as a layer, region, or substrate is referred to as being “on” another element, it can be directly on the other element or intervening elements may also be present. Furthermore, relative terms such as “inner,” “outer,” “upper,” “above,” “over,” “overlying,” “beneath,” “below,” “top,” “bottom,” and similar terms, may be used herein to describe a relationship between elements. It is understood that these terms are intended to encompass orientations of the device that differ from those depicted in the figures.

Although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

The figures are intended as schematic illustrations. As such, the actual dimensions and shapes of the devices and components (e.g., layer thicknesses) can be different, and departures from the illustrations as a result of, for example, of manufacturing techniques and/or tolerances may be expected. Embodiments should not be construed as limited to the particular shapes of the regions illustrated herein but are to include deviations in shapes that result from, for example, manufacturing. A region illustrated or described as square or rectangular may have rounded or curved features due to normal manufacturing tolerances. Thus, the regions illustrated in the figures are schematic in nature and their shapes are not intended to illustrate the precise shape of a region of a device and are not intended to limit the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

### DESCRIPTION OF EMBODIMENTS

Described herein is a red phosphor composition that has enhanced emission under the eye sensitivity curve. The phosphor composition may have a peak emission wavelength of between about 640 nm and about 670 nm and a FWHM of between about 40 nm and about 65 nm. The peak emission wavelength may also be between about 650 nm and about 660 nm, and the FWHM may be between 50 nm and 55 nm. The phosphor composition includes a primary phase and one or more additional phases, which may be identified using x-ray diffraction analysis. For example, the x-ray diffraction pattern of the phosphor composition includes a first intensity peak corresponding to the one or more additional phases at a 2-theta value of from about 26.5° to about 26.8°, as discussed in detail below.

The primary phase may include the elements Sr, Li, Al, N, and Eu, and may further have a chemical formula of Sr_{1-x-y}EuₓR_{y}[Li_{1-z}A_{z}Al₃₋ₐMₐN₄], where 0.001≦≦0.02, 0≦y≦0.5, 0≦z≦0.5, and 0≦a≦1.0, and where R is selected from the group consisting of Ca and Ba, A is selected from the group consisting of Na and K, and M is selected from the group consisting of B, Ga, Si, Ge, and C. For example, the primary phase may comprise Sr₁₋ₓEuₓ[LiAl₃N₄].

The one more additional phases are different from the primary phase and may comprise one or more oxides, fluorides, or nitrides, which may be byproducts of the reaction to form the primary phase. Thus, the one or more additional phases may include one or more binary, ternary and/or quaternary phases, such as, for example, a binary oxide (or fluoride or nitride) or a ternary oxide (or fluoride or nitride).

The one or more additional phases may be present in an amount greater than the amount of incidental impurities in the phosphor composition. For example, the one or more additional phases may be present in an amount of at least about 1 wt. %, where the weight percentage (wt. %) is measured with respect to the total weight of the phosphor composition. Typically, incidental impurities are present in the phosphor composition at a concentration of about 100 ppm or less, or about 10 ppm or less. The amount of the one or more additional phases is preferably at least about 5 wt. %, and more preferably at least about 12 wt. %. The amount may also be at least about 15 wt. %, at least about 20 wt. %, or at least about 25 wt. %. Typically, the one or more additional phases are present in an amount no greater than about 50 wt. %, no greater than 40 wt. %, or no greater than about 30 wt. %. The remainder of the phosphor composition is the primary phase and any incidental impurities.

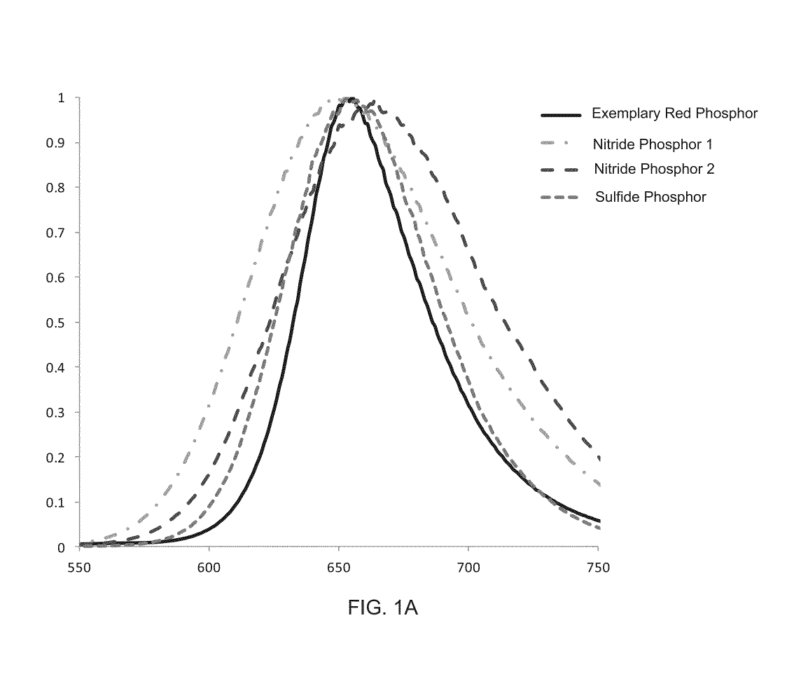

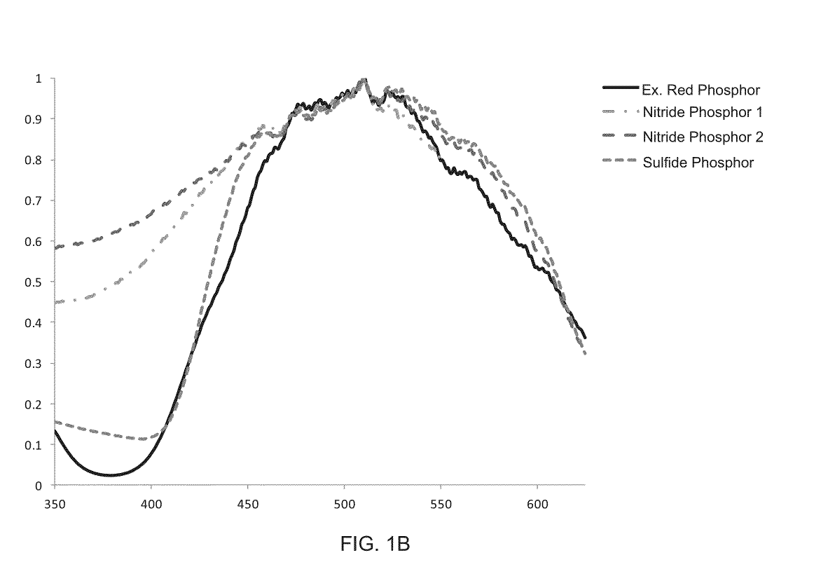

As indicated above, the phosphor composition comprising the primary phase and the one or more additional phases has a narrow emission spectrum that may improve the efficiency of light emitted under the photopic eye sensitivity curve. FIG. 1A shows an emission spectrum and FIG. 1B shows an excitation spectrum for an exemplary red phosphor composition in comparison with emission spectra obtained from three conventional red phosphors, specifically, two commercially available CaAlSiN₃ (nitride) phosphors and a sulfide phosphor. As can be seen from the emission spectra, the exemplary red phosphor composition, which corresponds to “phosphor composition 1” described below, has a much narrower emission spectra (FWHM of about 52 nm and peak emission of about 655 nm) compared to the nitride and sulfide phosphors, which have FWHM values in the range of about 80-90 nm.

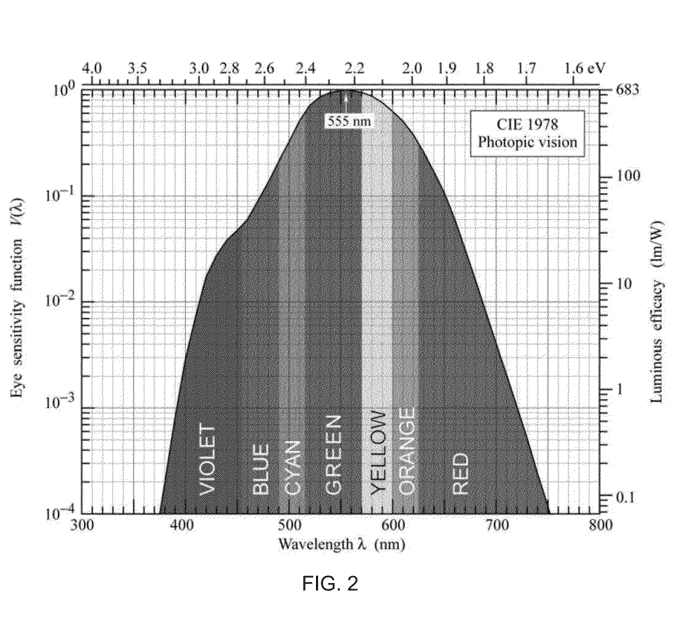

FIG. 2 shows the eye sensitivity function V(λ) and luminous efficacy, measured in lumens per watt of optical power (right hand axis). V(λ) is a maximum at 555 nm, after 1978 CIE data. Given the position of the peak emission and the relatively narrow FWHM of the exemplary red phosphor composition, an increased amount of the light emission falls under the eye sensitivity curve.

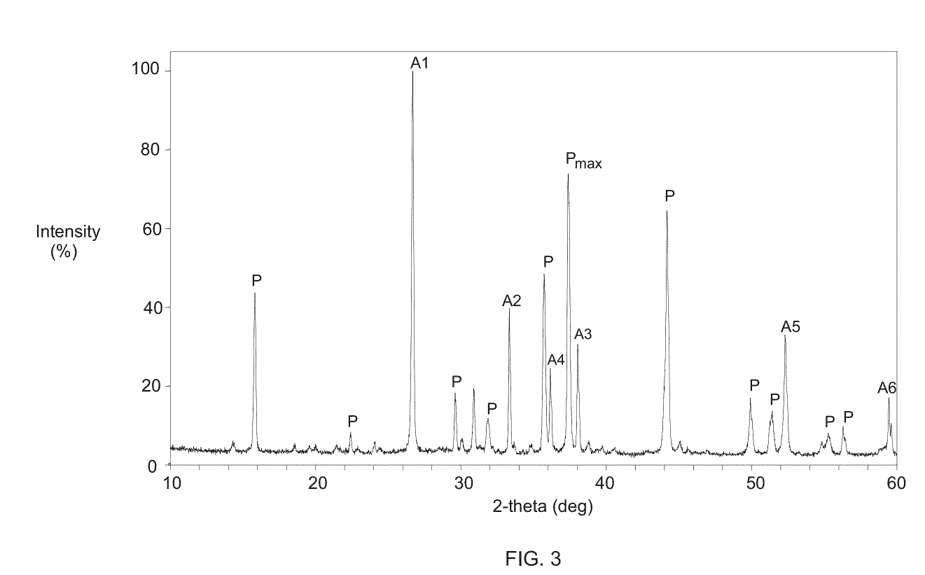

The one or more additional phases may contribute to the luminescence as the phosphor performance is diminished when the additional phase(s) are not present or present in lower amounts. The phases in the red phosphor composition may be identified on the basis of x-ray diffraction data. FIGS. 3 to 5 show x-ray diffraction patterns obtained from exemplary phosphor compositions prepared as described below. The exemplary phosphor compositions include a primary phase comprising Sr₁₋ₓEuₓ[LiAl₃N₄] and one or more additional phases. Intensity peaks corresponding to the primary phase are labeled as P and intensity peaks corresponding to the one or more additional phases are labeled as A followed by a number (e.g., A1, A2) to distinguish the various peaks.

To prepare the exemplary phosphor compositions, reactant powders (precursors) are mixed in a desired ratio and placed in a first refractory crucible (e.g., an inner crucible comprising Mo, W, or BN). The following precursors are used to prepare phosphor compositions 1, 2 and 3, respectively: Sr₂N, AlN, EuF₃, Li and 10 wt. % NH₃F as a flux (#1); Sr₂N, AlN, Al, EuF₃, and LiF, where the molar ratio of AlN to Al is 1:1 (#2) and 50% of the aluminum comes from the AlN source and 50% from Al powder; and Sr₂N, AlN, EuF₃, LiF and NaF (#3).

TABLE 1
Precursors Used to Prepare Exemplary Phosphor Compositions

| Phosphor | Precursor Comprising: | | | | | | | |
|---|---|---|---|---|---|---|---|---|
| Composition | Sr | Li | Al | Eu | R | A | M | Flux |
| 1 | Sr₂N | LiF | AlN | EuF₃ | | | | NH₃F |
| 2 | Sr₂N | LiF | AlN, | EuF₃ | | | | |
| | | | Al | | | | | |
| 3 | Sr₂N | LiF | AlN | EuF₃ | | NaF | | |

The first refractory crucible containing the precursors is subsequently enclosed in a second refractory crucible (e.g., an outer crucible comprising Al₂O₃ or ZrO₂) and heated in a box furnace in a reducing atmosphere of 5% H₂ in N₂ to a temperature of about 1000° C. The duration of the heating in these examples is from two to five hours, although other heating durations are possible, as discussed below. After firing (heating), the resulting phosphor composition may be further processed using conventional powder processing methods to achieve the desired particle size.

The phosphor compositions are characterized using x-ray diffraction and photoluminescence measurements. X-ray diffraction (XRD) is carried out using a Bruker D2 Phaser with LINXEYE detector to obtain plots of diffraction intensity versus 2-theta value. The XRD data are collected from 10 to 60 degrees (2-theta) with a step of 0.0142 deg, a current of 10 mA and voltage of 30 kV. The peak position of a given diffraction peak may be defined as the 2-theta value corresponding to the maximum value of intensity for that peak. Photoluminescence measurements are made using a Hitachi F-7000 Fluorescence Spectrophotometer. Emission spectra are collected using a 450 nm excitation source and the peak emission wavelength is measured and recorded. Excitation spectra are measured by varying the excitation wavelength while monitoring the emission intensity at the pre-determined peak emission wavelength.

FIGS. 3 to 5 show diffraction intensity versus 2-theta for exemplary phosphor compositions 1, 2 and 3, respectively. As indicated above, intensity peaks corresponding to the primary phase are labeled as P and intensity peaks corresponding to the one or more additional phases are labeled as A followed by a number (e.g., A1, A2) to distinguish the various peaks. Among the intensity peaks corresponding to the primary phase, there is a maximum intensity peak at a 2-theta value of from about 37.2° to about 37.5°. The maximum intensity peak for the primary phase is labeled as Pₘₐₓ.

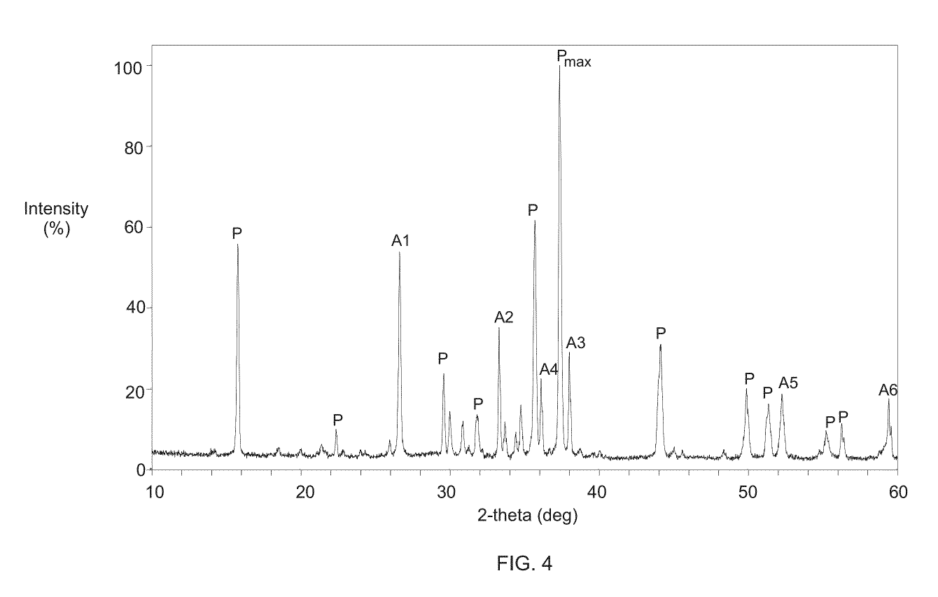

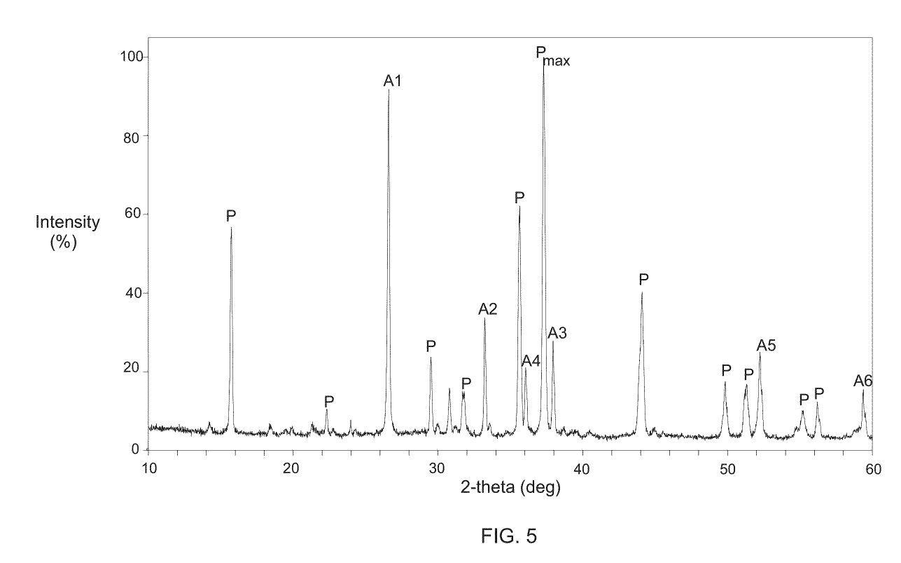

Among the intensity peaks corresponding to the one or more additional phases, there is a first intensity peak A1 at a 2-theta value of from about 26.5° to about 26.8°. The 2-theta value may also lie in the range of from about 26.6° to about 26.7°. The first intensity peak A1 may comprise an intensity of at least about 50% of the intensity of the maximum intensity peak corresponding to the primary phase. For example, the first intensity peak A1 shown in FIG. 3 comprises an intensity of about 135% of the intensity of the maximum intensity peak Pₘₐₓ; the first intensity peak A1 shown in FIG. 4 comprises an intensity of about 54% of the intensity of Pₘₐₓ; and the first intensity peak A1 shown in FIG. 5 comprises an intensity of about 92% of the intensity of Pₘₐₓ. In some embodiments, the intensity of the first intensity peak A1 may be at least about 60%, at least about 70%, at least about 80%, at least about 90%, or at least about 100% of the intensity of the maximum intensity peak of the primary phase.

The x-ray diffraction pattern may further comprise a second intensity peak A2 corresponding to the one or more additional phases at a 2-theta value of from about 33.1° to about 33.4°. The 2-theta value may also lie in the range of from about 33.2° to about 33.3°. The second intensity peak A2 may comprise an intensity of at least about 30% of the intensity of the maximum intensity peak Pₘₐₓ. For example, the second intensity peak A2 shown in FIG. 3 comprises an intensity of about 54% of the intensity of the maximum intensity peak Pₘₐₓ; the second intensity peak A2 shown in FIG. 4 comprises an intensity of about 35% of the intensity of Pₘₐₓ; and the second intensity peak A2 shown in FIG. 5 comprises an intensity of about 34% of the intensity of Pₘₐₓ. In some embodiments, the intensity of the second intensity peak A2 may be at least about 35%, at least about 40%, at least about 45%, at least about 50%, or at least about 55% of the intensity of the maximum intensity peak of the primary phase.

The x-ray diffraction pattern may further comprise a third intensity peak corresponding to the one or more additional phases at a 2-theta value of from about 37.8° to about 38.1°. The 2-theta value may also lie in the range of from about 37.9° to about 38.0°. The third intensity peak may comprise an intensity of at least about 25% of an intensity of the maximum intensity peak Pₘₐₓ. For example, the third intensity peak A3 shown in FIG. 3 comprises an intensity of about 42% of the intensity of the maximum intensity peak Pₘₐₓ; the third intensity peak A3 shown in FIG. 4 comprises an intensity of about 29% of the intensity of Pₘₐₓ; and the third intensity peak A3 shown in FIG. 5 comprises an intensity of about 28% of the intensity of Pₘₐₓ. In some embodiments, the intensity of the third intensity peak A3 may be at least about 30%, at least about 35%, at least about 40%, or at least about 45% of the intensity of the maximum intensity peak of the primary phase.

The x-ray diffraction pattern may further comprise a fourth intensity peak corresponding to the one or more additional phases at a 2-theta value of from about 36.0° to about 36.3°. The 2-theta value may also lie in the range of from about 36.1° to about 36.2°. The fourth intensity peak may comprise an intensity of at least about 20% of an intensity of the maximum intensity peak Pₘₐₓ. For example, the fourth intensity peak A4 shown in FIG. 3 comprises an intensity of about 33% of the intensity of the maximum intensity peak Pₘₐₓ; the fourth intensity peak A4 shown in FIG. 4 comprises an intensity of about 23% of the intensity of Pₘₐₓ; and the fourth intensity peak A4 shown in FIG. 5 comprises an intensity of about 21% of the intensity of Pₘₐₓ. In some embodiments, the intensity of the fourth intensity peak A4 may be at least about 25%, at least about 30%, or at least about 35% of the intensity of the maximum intensity peak of the primary phase.

The x-ray diffraction pattern may further comprise a fifth intensity peak corresponding to the one or more additional phases at a 2-theta value of from about 52.1° to about 52.4°. The 2-theta value may also lie within the range of from about 52.2° to about 52.3°. The fifth intensity peak may comprise an intensity of at least about 18% of an intensity of the maximum intensity peak Pₘₐₓ. For example, the fifth intensity peak A5 shown in FIG. 3 comprises an intensity of about 45% of the intensity of the maximum intensity peak Pₘₐₓ; the fifth intensity peak A5 shown in FIG. 4 comprises an intensity of about 19% of the intensity of Pₘₐₓ; and the fifth intensity peak A5 shown in FIG. 5 comprises an intensity of about 25% of the intensity of Pₘₐₓ. In some embodiments, the intensity of the fifth intensity peak A5 may be at least about 20%, at least about 25%, at least about 30%, or at least about 35% of the intensity of the maximum intensity peak of the primary phase.

The x-ray diffraction pattern may further comprise a sixth intensity peak corresponding to the one or more additional phases at a 2-theta value of from about 59.3° to about 59.6°. The 2-theta value may also lie within the range of from about 59.4° to about 59.5°. The sixth intensity peak may comprise an intensity of at least about 12% of an intensity of the maximum intensity peak Pₘₐₓ. For example, the sixth intensity peak A6 shown in FIG. 3 comprises an intensity of about 23% of the intensity of the maximum intensity peak Pₘₐₓ; the sixth intensity peak A6 shown in FIG. 4 comprises an intensity of about 18% of the intensity of Pₘₐₓ; and the sixth intensity peak A6 shown in FIG. 5 comprises an intensity of about 15% of the intensity of Pₘₐₓ. In some embodiments, the intensity of the sixth intensity peak A6 may be at least about 15%, at least about 18%, at least about 22%, or at least about 25% of the intensity of the maximum intensity peak of the primary phase.

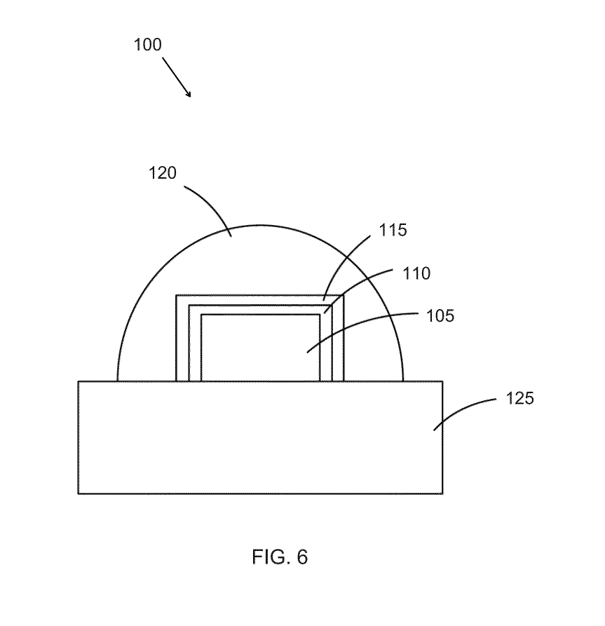

The phosphor composition described herein may be used in a light emitting diode (LED) component. Accordingly, as shown schematically in FIG. 6, the LED component 100 may include a blue LED 105 comprising a dominant wavelength in a range of from about 425 nm to less than 475 nm; and a red phosphor composition 110 in optical communication with the LED, where the phosphor composition 110 comprises a primary phase and one or more additional phases. The phosphor composition also may have a peak emission wavelength of between about 640 nm and about 670 nm and a FWHM of between about 40 nm and about 65 nm. The peak emission wavelength may also be between about 650 nm and about 660 nm, and the FWHM may be between about 50 nm and about 55 nm. The primary phase and the one or more additional phases of the phosphor composition may have any of the characteristics set forth in the present disclosure. For example, the primary phase may have a chemical formula of Sr_{1-x-y}EuₓR_{y}[Li_{1-z}A_{z}Al₃₋ₐMₐN₄], where 0.001≦≦0.02, 0≦y≦0.5, 0≦z≦0.5, and 0≦a≦1.0 and where R is selected from the group consisting of Ca and Ba, A is selected from the group consisting of Na and K, and M is selected from the group consisting of B, Ga, Si, Ge, and C. The one or more additional phases may be identified on the basis of x-ray diffraction data. As described above, the x-ray diffraction pattern of the phosphor composition may include a first intensity peak corresponding to the one or more additional phases at a 2-theta value of from about 26.5° to about 26.8°. The first intensity peak may have an intensity of at least about 50% of the intensity of a maximum intensity peak of the primary phase.

The LED component 100 may further include other phosphors in addition to the red phosphor composition 110. For example, the LED component may include an additional red phosphor composition 115 with a peak emission in the range of from about 600 nm to less than 640 nm or from about 610 nm to about 630 nm. The two red phosphor compositions 110, 115 may work synergistically to maximize the output of light under the eye sensitivity curve. The inventive red phosphor composition 110 may boost CRI and R9 values, while the additional red phosphor composition 115 may boost L_{f}. Examples of suitable additional red phosphor compositions 115 include Ca_{1-x-y}SrₓEu_{y}SiAlN₃, where 0≦x≦1, and Sr₂₋ₓEuₓSi₅N₈, where 0<x<2. The LED component may also or alternatively comprise a green or yellow phosphor composition.

The phosphor compositions may be mixed together or positioned separately, such as in discrete layers with a single type of phosphor in each layer. The phosphor compositions may be coated directly on one or more surfaces of the blue LED 105, as illustrated for example in FIG. 6. The phosphor compositions may also or alternatively be positioned remotely, such as on or within a lens or optic 120 of the LED component 100. Phosphor layer(s) applied directly to the blue LED 105 may be disposed on any or all surfaces of the LED, including the sidewalls and/or top surface, and the layer(s) may also extend onto the submount 125. In one example, a first phosphor layer applied to the blue LED 105 or overlying lens 120 may include the red phosphor composition 110, and a second phosphor layer above or below the first layer may include the additional red phosphor composition (or a green or yellow phosphor composition) 115, etc. In some embodiments, the phosphor compositions may be processed to form a pellet or disc and positioned in a remote location with respect to the blue LED.

The phosphor compositions may be mixed with a binder (e.g., a silicone encapsulant) prior to use. Deposition of the phosphor compositions may entail spray coating or another suitable method, such as one of the deposition techniques described in the following patent publications: U.S. Pat. No. 8,232,564 entitled “Wafer Level Phosphor Coating Method and Devices Fabricated Utilizing Method,” U.S. Patent Application Publication No. 2010/0155763 entitled “Systems and Methods for Application of Optical Materials to Optical Elements,” and U.S. Patent Application Publication No. 2008/0179611 entitled “Wafer Level Phosphor Coating Method and Devices Fabricated Utilizing Method,” which are hereby incorporated by reference in their entirety.

The blue LED shown schematically in FIG. 6 may be a Group III nitride-based LED formed from nitrogen and Group III elements such as aluminum, gallium and/or indium in the form of nitride layers epitaxially grown and doped as known in the art to produce a blue LED that may preferentially emit blue light at wavelengths from 425 nm to 475 nm. In some cases, the blue LED may preferentially emit shorter wavelength blue light, e.g., at wavelengths from about 425 nm to less than 460 nm. The blue LED may be disposed on a submount 125 as shown in FIG. 6. LED components containing the blue LED may be fabricated using methods known in the art.

A method of making a phosphor composition as described above entails forming a reaction mixture comprising: a first precursor comprising Sr; a second precursor comprising Li; a third precursor comprising Al; and a fourth precursor comprising Eu. The reaction mixture is heated in an environment comprising nitrogen at a temperature sufficient to form a phosphor composition comprising a primary phase and one or more additional phases, where the primary phase comprises Sr, Li, Al, N, and Eu. An x-ray diffraction pattern of the phosphor composition comprises a first intensity peak corresponding to the one or more additional phases at a 2-theta value of from about 26.5° to about 26.8°. The first intensity peak may have an intensity of at least about 50% of the intensity of a maximum intensity peak of the primary phase.

The first precursor used to form the reaction mixture may have a composition selected from the group consisting of Sr₂N, Sr₃N, Sr₃N₂ and SrH₂. The second precursor may have a composition selected from the group consisting of LiF and Li₃N. The third precursor may have a composition selected from the group consisting of AlN and AlF₃. The fourth precursor may have a composition comprising EuF₃. For example, the first precursor may be Sr₂N, the second precursor may be LiF, the third precursor may be AlN, and the fourth precursor may be Eu F₃.

The reaction mixture may further comprise a fifth precursor comprising R, where R is selected from Ca and Ba. The fifth precursor may have a composition selected from the group consisting of Ca₃N₂, CaH₂, Ba₃N₂ and BaH₂. The reaction mixture may also or alternatively further comprise a sixth precursor comprising A, where A is selected from the group consisting of Na and K. The sixth precursor may have a composition selected from the group consisting of NaF and KF. The reaction mixture may also or alternatively further comprise a seventh precursor M, where M is selected from the group consisting of B, Ga, Si, Ge, and C. The seventh precursor may have a composition selected from the group consisting of BN, GaN, GaF₃, Si₃N₄, SiC, Ge₃N₄, graphite, carbon black, and diamond dust. The reaction mixture may further include a flux, such as NH₃F. Generally, the flux may be present in the reaction mixture at a concentration of up to about 10 wt. %. For example, the concentration of the flux may be at least about 4 wt. %, at least about 6 wt. %, or at least about 8 wt. %.

The environment in which the reaction mixture is heated may be a reducing environment that comprises a forming gas, e.g., nitrogen gas (N₂) and optionally hydrogen gas (H₂). For example, a mixture of nitrogen gas and hydrogen gas including up to about 10% H₂, or up to about 5% H₂, may be suitable for the forming gas. Typically, a mixture of about 95% N₂ and about 5% H₂ is used to obtain the desired phosphor composition. In some examples, the forming gas may be entirely hydrogen (e.g., up to 100% H₂). The reaction may be carried out in a chamber comprising an outer vessel and lid and containing a crucible for holding the precursors. The crucible may be made of one or more refractory materials, such as a ceramic or a refractory metal. For example, the crucible may comprise Al₂O₃. During the reaction, the forming gas may be flowed continuously through the chamber.

The precursors are particulate materials (powders) that may have a median (d50) particle size in the range of from about 1 micron to about 200 microns, from 1 micron to about 25 microns, from about 4 microns to about 14 microns, or from about 5 microns to about 10 microns. Any of the precursor powders may be mechanically milled or otherwise processed (e.g., by jet milling) in order to reduce the average particle size of the powder before adding the precursor to the reaction mixture. For example, the precursor powders may be milled using a commercially available jet milling apparatus, which utilizes high pressure air to break up larger particles into smaller particles. Mechanical milling as described above may also be used to reduce the particle size of the phosphor composition formed from the reaction mixture. The phosphor composition may also treated with (dilute) acid to remove unwanted phases.

The heating of the reaction mixture may be carried out at temperature in the range of from about 800° C. to about 1300° C., and the heating may be carried out for a time duration of from 1 minute to 1 week. For example, the temperature of the heating may be from about 950° C. to about 1050° C., and the time duration of the heating may be from 1 hour to 8 hours. In another example, the temperature of the heating may be from about 800° C. to less than 900° C. (or less than 925° C., or less than 950° C.), and the heating may be carried out for a time duration of at least about 24 hours. The time duration may also be at least about 72 hours, or at least about 120 hours.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A phosphor composition with enhanced emission under the eye sensitivity curve, the phosphor composition comprising:
a primary phase and one or more additional phases,
wherein an emission spectrum of the phosphor composition has a peak emission wavelength of between about 640 nm and about 670 nm and a FWHM of between about 40 nm and about 65 nm, and
wherein an x-ray diffraction pattern of the phosphor composition comprises a first intensity peak corresponding to the one or more additional phases at a 2-theta value of from about 26.5° to about 26.8°.

2. The phosphor composition of claim 1, wherein the peak emission wavelength is between about 650 nm and about 660 nm, and wherein the FWHM is between about 50 nm and about 55 nm.

3. The phosphor composition of claim 1, wherein the first intensity peak comprises an intensity of at least about 50% of an intensity of a maximum intensity peak of the primary phase.

4. The phosphor composition of claim 3, wherein the maximum intensity peak of the primary phase is at a 2-theta value of from about 37.2° to about 37.5°.

5. The phosphor composition of claim 1, wherein the primary phase comprises a chemical formula of Sr_{1-x-y}EuₓR_{y}[Li_{1-z}A_{z}Al₃₋ₐMₐN₄], where 0.001≦≦0.02, 0≦y≦0.5, 0≦z≦0.5, and 0≦a≦1.0, and where R is selected from the group consisting of Ca and Ba, A is selected from the group consisting of Na and K, and M is selected from the group consisting of B, Ga, Si, Ge, and C.

6. The phosphor composition of claim 5, where y=z=a=0, and the chemical formula is Sr₁₋ₓEuₓ[LiAl₃N₄].

7. The phosphor composition of claim 1, wherein the x-ray diffraction pattern further comprises a second intensity peak at a 2-theta value of from about 33.1 to about 33.4, the second intensity peak corresponding to the one or more additional phases.

8. The phosphor composition of claim 7, wherein the second intensity peak comprises an intensity of at least about 30% of an intensity of a maximum intensity peak of the primary phase.

9. The phosphor composition of claim 1, wherein the one or more additional phases are present in an amount of at least about 12 wt. %.

10. A light emitting diode (LED) component comprising:
an LED comprising a dominant wavelength in a range of from about 425 nm to about 475 nm;
the phosphor composition of claim 1 in optical communication with the LED.

11. A phosphor composition with enhanced emission under the eye sensitivity curve, the phosphor composition comprising:
a primary phase and one or more additional phases,
wherein the primary phase comprises a chemical formula of Sr_{1-x-y}EuₓR_{y}[Li_{1-z}A_{z}Al₃₋ₐMₐN₄], where 0.001≦≦0.02, 0≦y≦0.5, 0≦z≦0.5, and 0≦a≦1.0, and where R is selected from the group consisting of Ca and Ba, A is selected from the group consisting of Na and K, and M is selected from the group consisting of B, Ga, Si, Ge, and C, and
wherein an x-ray diffraction pattern of the phosphor composition comprises a first intensity peak corresponding to the one or more additional phases at a 2-theta value of from about 26.5° to about 26.8°.

12. The phosphor composition of claim 11, wherein the first intensity peak comprises an intensity of at least about 50% of an intensity of a maximum intensity peak of the primary phase.

13. The phosphor composition of claim 11, where y=z=a=0, and the chemical formula is Sr₁₋ₓEuₓ[LiAl₃N₄].

14. A light emitting diode (LED) component comprising:
an LED comprising a dominant wavelength in a range of from about 425 nm to about 475 nm;
the phosphor composition of claim 11 in optical communication with the LED.

15. A light emitting diode (LED) component comprising:
an LED comprising a dominant wavelength in a range of from about 425 nm to about 475 nm;
a first phosphor composition and a second phosphor composition in optical communication with the LED,
wherein the first phosphor composition comprises an emission spectrum having a peak emission wavelength of between about 640 nm and about 670 nm and a FWHM of between about 40 nm and 65 nm, and
wherein the second phosphor composition comprises an emission spectrum having a peak emission wavelength of from about 600 nm to less than 640 nm.

16. The LED component of claim 15, wherein the peak emission wavelength of the first phosphor composition is between about 650 nm and about 660 nm and wherein the FWHM is between about 50 and 55 nm.

17. The LED component of claim 15, wherein the peak emission wavelength of the second phosphor composition is between about 610 nm and about 630 nm.

18. The LED component of claim 15, wherein the first phosphor composition comprises a primary phase having a chemical formula of Sr_{1-x-y}EuₓR_{y}[Li_{1-z}A_{z}Al₃₋ₐMₐN₄], where 0.001≦≦0.02, 0≦y≦0.5, 0≦z≦0.5, and 0≦a≦1.0, and where R is selected from the group consisting of Ca and Ba, A is selected from the group consisting of Na and K, and M is selected from the group consisting of B, Ga, Si, Ge, and C.

19. The LED component of claim 15, wherein the first phosphor composition and the second phosphor composition are mixed together.

20. The LED component of claim 15, comprising a first phosphor layer comprising the first phosphor composition and a second phosphor layer comprising the second phosphor composition, the first phosphor layer being disposed above or below the second phosphor layer.

21. A method of making a phosphor composition, the method comprising:
forming a reaction mixture comprising:
a first precursor comprising Sr;
a second precursor comprising Li;
a third precursor comprising A1;
a fourth precursor comprising Eu;
heating the reaction mixture in an environment comprising nitrogen gas at a temperature sufficient to form a phosphor composition comprising a primary phase and one or more additional phases, the primary phase comprising Sr, Li, Al, N, and Eu,
wherein an x-ray diffraction pattern of the phosphor composition comprises a first intensity peak at a 2-theta value of from about 26.5° to about 26.8°, the first intensity peak corresponding to the one or more additional phases.

22. The method of claim 21, wherein the first precursor has a composition selected from the group consisting of Sr₂N, Sr₃N, Sr₃N₂ and SrH₂, wherein the second precursor has a composition selected from the group consisting of LiF and Li₃N, wherein the third precursor has a composition selected from the group consisting of AlN and AlF₃, and wherein the fourth precursor has a composition comprising Eu F₃.

23. The method of claim 21, wherein the temperature is from about 800° C. to about 1300° C., and wherein the heating is carried out for a time duration of from 1 minute to 1 week.

24. The method of claim 23, wherein the temperature is from about 950° C. to about 1050° C. and the heating is carried out for a time duration of from 1 hour to 8 hours.

25. The method of claim 23, wherein the temperature is from about 800° C. to less than 950° C. and the heating is carried out for a time duration of at least about 24 hours.
